(19) United States
(12) Patent Application Publication
(10) Pub. No.: US 2014/0306516 A1
(43) Pub. Date: Oct. 16, 2014

(54) VIBRATION-DAMPED TRACK SHOE FOR MOBILE MACHINE

(71) Applicant: CATERPILLAR INC., Peoria, IL (US)

(72) Inventors: Daniel I. KNOBLOCH, Morton, IL (US); Kevin L. STEINER, Tremont, IL (US); Martin T.J. XAVIER, TamilNadu (IN)

(73) Assignee: Caterpillar Inc., Peoria, IL (US)

(21) Appl. No.: 13/863,908

(22) Filed: Apr. 16, 2013

(51) Int. Cl. B62D 55/096; B62D 55/20; B62D 55/26

(52) U.S. Cl. CPC B62D 55/096; B62D 55/26; B62D 55/20
USPC 305/46

(57) ABSTRACT

A track shoe is disclosed for use with a mobile machine. The track shoe may have a base plate with an inner surface and an outer surface, and a grouser bar extending from the outer surface away from the base plate. The track shoe may also have a vibration damping coating applied to opposing ends of the base plate at the inner surface. The vibration damping coating may have a thickness about equal to a thickness of the base plate.

### TECHNICAL FIELD

The present disclosure relates generally to a track shoe and, more particularly, to a vibration-damped track shoe for a mobile machine.

### BACKGROUND

A track-type mobile machine utilizes tracks located at either side of the machine to propel the machine. The tracks include chains having links pined end-to-end to form a loop that extends around a drive sprocket and one or more idler wheels, and ground engaging elements known as track shoes connected to each link of the chains. The sprocket is driven by an engine of the machine to rotate the chains and push the track shoes against a work surface, thereby transmitting torque from the sprocket to the surface in opposition to a desired travel direction of the machine.

Each track component of the machine is generally metallic, and the engagement of the different components with each other produces noise. For example, as the sprocket engages bushings in the chain links, the engagement creates vibration. This vibration is transmitted from the chain links to the track shoes, and vibration of the track shoes can be heard as a ringing sound by the operator and others in the vicinity of the mobile machine.

One attempt to reduce the noise generated by a machine's tracks is disclosed in U.S. Pat. No. 4,099,796 that issued to Groff on Jul. 11, 1978 (“the '796 patent). Specifically, the '796 patent discloses a track shoe assembly having a track shoe and a cover plate generally covering an inner surface of the track shoe. The track shoe includes a middle portion and first and second end portions. The cover plate has a seat that engages the middle portion of the track shoe, so as to maintain the cover plate spaced apart from the first and second end portions. A viscoelastic material is positioned at the first and second end portions, between the shoe and the cover plate (i.e., the cover plate provides a retaining wall for the viscoelastic material). The viscoelastic material is silicon based, or a thermoplastic that is capable of being bonded to the shoe. The viscoelastic material covers about two-thirds of the shoe's total width (i.e., one-third at each end portion), and has a thickness of about 0.01-0.12 inches. Deflection forces on the shoe and cover plate are transmitted into the viscoelastic material, where they are changed to shear forces and dissipated by or absorbed into the material. The track shoe assemblies are connected to a continuous track by bolts that pass through the cover plate and the shoe of each assembly.

While the track shoe assemblies of the '796 patent may help reduce machine noise, they may still be less than optimal. In particular, the cover plate may add extra weight and cost to the machine. In addition, after the viscoelastic material has worn away, it may be possible for the cover plate to vibrate excessively and/or for the connection between the cover plate and the shoe to break or loosen.

The disclosed track shoe is directed to overcoming one or more of the problems set forth above.

### SUMMARY

In one aspect, the present disclosure is related to a track shoe for a mobile machine. The track shoe may include a base plate with an inner surface and an outer surface, and a grouser bar extending from the outer surface away from the base plate. The track shoe may also include a vibration damping coating applied to opposing ends of the base plate at the inner surface. The vibration damping coating may have a thickness about equal to a thickness of the base plate.

In another aspect, the present disclosure is related to another track shoe for a mobile machine. This track shoe may include a base plate with an inner surface and an outer surface, and a grouser bar extending from the outer surface away from the base plate. The track shoe may also include a polyurethane coating bonded to the inner surface at opposing ends of the base plate. The polyurethane coating may cover about 40-50% of a width of the base plate.

### BRIEF DESCRIPTION OF THE DRAWINGS

FIG. 1 is an isometric illustration of an exemplary disclosed mobile machine;

FIG. 2 is a side view illustration of an exemplary disclosed track shoe that may be used in conjunction with the mobile machine of FIG. 1; and

FIG. 3 is an isometric illustration of the track shoe shown in FIG. 2.

### DETAILED DESCRIPTION

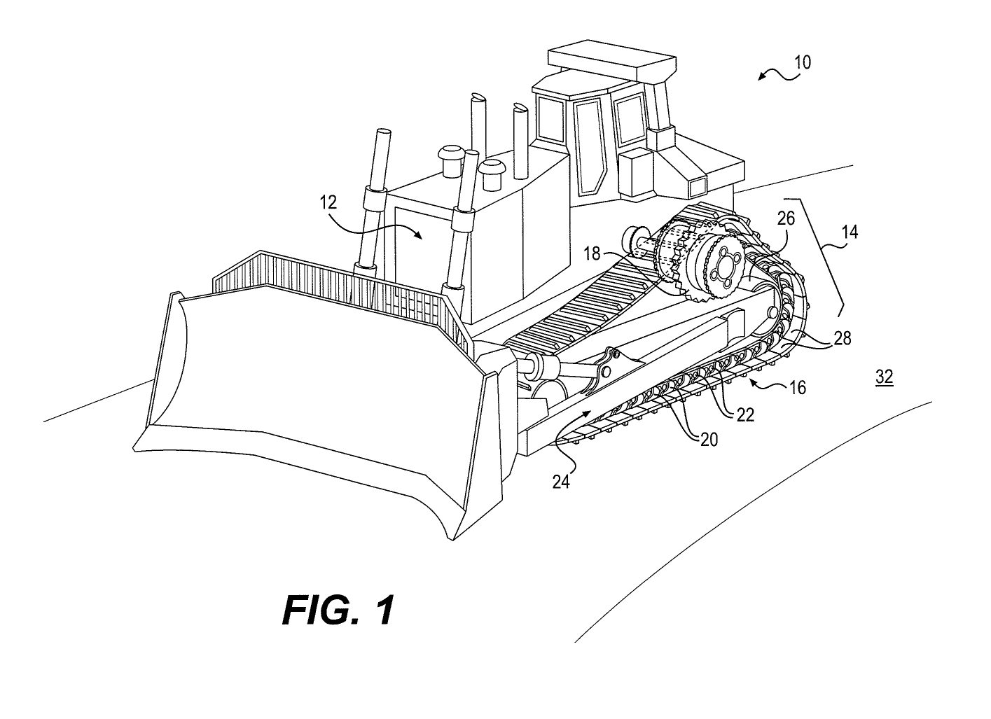

FIG. 1 illustrates a track type mobile machine 10 having an engine 12 configured to drive a tracked undercarriage 14. Mobile machine 10 may be any machine that performs an operation associated with an industry such as mining, construction, farming, or any other industry known in the art. For example, machine 10 may be a material moving machine such as a dozer, a loader, an excavator, or any other material moving machine.

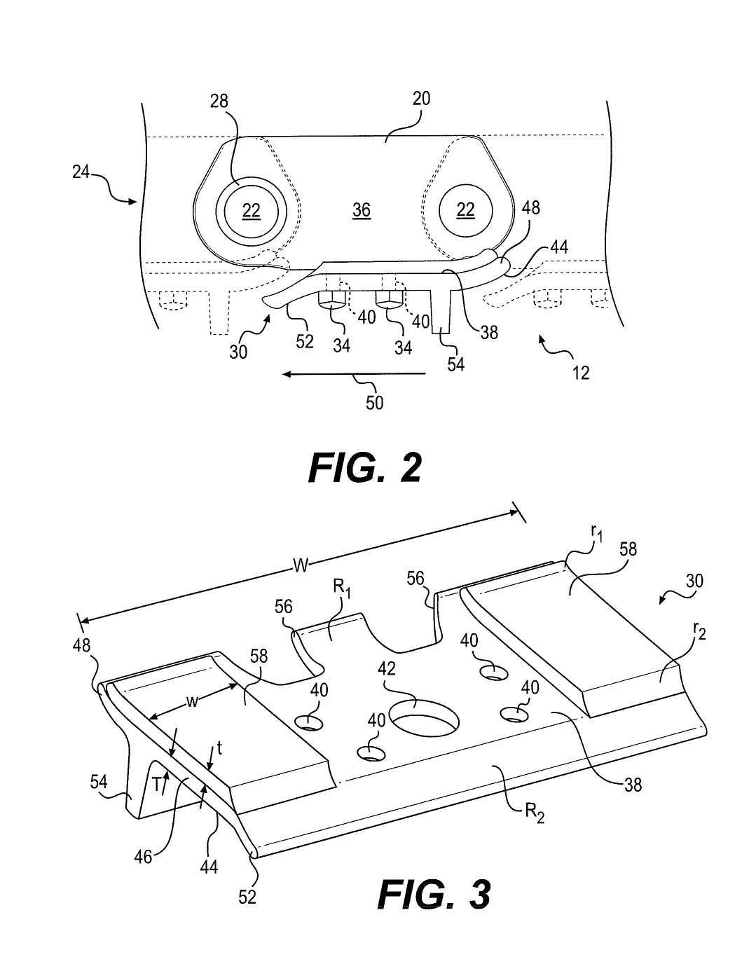

Undercarriage 14 may include parallel tracks 16 located at opposing sides of machine 10 that are driven by engine 12 via corresponding sprockets 18 (only one track 16 and one sprocket 18 are shown in FIG. 1). Each track 16 may include a plurality of links 20 connected end-to-end via pins 22 to form an endless chain 24. Chains 24 may be wrapped around corresponding sprockets 18 and idler wheels 26 (e.g., a front idler wheel and, in the disclosed embodiment, a rear idler wheel at each side of machine 10). Sprockets 18 may engage bushings 28 (shown only in FIG. 2) that encase pins 22 and thereby transmit torque from engine 12 to chains 24. Idler wheels 26 may guide chains 24 in an elliptical trajectory around sprockets 18. A track shoe 30 may be removably connected to each link 20 of chains 24 and function to transmit the torque of chains 24 as a driving linear force into a ground surface 32.

As shown in FIG. 2, each track shoe 30 may be joined to links 20 by a plurality of threaded fasteners 34. In general, link 20 may include two opposing side members 36 (only one shown in FIG. 2) held together by pins 22 and bushings 28, and each track shoe 30 may include an inner surface 38 configured to directly engage corresponding outer edges of each pairing of side members 36. Two or more fasteners 34 may pass through respective holes 40 formed within track shoe 30 and into threaded bores (not shown) within each side member 36. In this configuration, tightening of fasteners 34 may press track shoe 30 against link 20.

Each track shoe 30 may further include an opening 42 substantially centered between opposing rows of holes 40 associated with each side member 36 of link 20. Opening 42 may pass from an outer surface 44 through inner surface 38, and be configured to allow debris to pass through track shoe 30 and between side members 36 of link 20. It is contemplated that opening 42 may be disposed in a different position relative to holes 40 and/or that track shoe 30 may include additional openings, if desired. It is also contemplated that opening 42 may be omitted from a particular embodiment.

As shown in FIG. 3, each track shoe 30 may include a base plate 46 having a trailing end 48 (relative to a forward travel direction of machine 10 designated by an arrow 50 in FIG. 2) and a leading end 52, and a transverse grouser bar 54 located closer to trailing end 48. Base plate 46 may be substantially rounded at trailing and leading ends 48, 52, the rounded shape helping to increase a clearance between the trailing end 48 of one track shoe 30 and the leading end 52 of an immediately rearward track shoe 30. Grouser bar 54 may protrude from outer surface 44 away from base plate 46 to engage and penetrate a desired distance into ground surface 32, thereby providing enhanced traction properties. Trailing end 48 may be generally curved away from grouser bar 54 and, in the disclosed embodiment, have a concave curvature R₁ at internal surface 40 of about 40-55 mm. In contrast, leading end 52 may be generally curved toward grouser bar 54 and, in the disclosed embodiment, have a concave curvature R₂ at internal surface 40 of about 100-150 mm. The curvature at trailing and leading ends 48, 52 may provide further clearance for adjacent and overlapping track shoes 30 that is required to avoid contact as track shoes 30 pivot relative to each other during rotation about sprocket 18 and/or idler wheels 26 (referring to FIG. 1). Base plate 46 may be generally planar between trailing and leading ends 48, 52.

Base plate 46 may include one or more cutouts or recesses 56 at trailing end 48. Recesses 56 may be substantially U-shaped, square, rectangular, and/or any other like shape. Recesses 56 may be configured and/or positioned to accept a portion of chain 24 (e.g., outer edges of side members 36 associated with adjacent links 20—see FIG. 2) during movement of undercarriage 14.

Base plate 46 and grouser bar 54 may together be integrally forged or cast, and in such exemplary embodiments, one or more of holes 40, openings 42, and/or recesses 56 may be formed in track shoe 30 during such a process. In still further exemplary embodiments, an ingot or bloom of desired material may be rolled and/or otherwise formed into lengths having a desired track shoe profile. Such rolled lengths may be referred to as “special sections,” and individual base plates 46 may be cut from the rolled special sections. Holes 40, openings 42, recesses 56, grouser bars 54, and/or other elements of track shoes 30 may then be formed within or otherwise connected to the individual track shoes 30 through cutting, drilling, etching, welding, and/or other known processes.

Base plate 46 and grouser bar 54 may be formed from any metal known in the art such as, for example, steel, aluminum, and/or alloys thereof. In an exemplary embodiment, both base plate 46 and grouser bar 54 may be formed from a single material having a relatively low mass, high yield strength. These materials may include, for example, SAE 15B34 steel, SAE 40BV40 steel, SAE 15B27 steel, and/or other like materials. Such materials may be hardened through cladding and/or other known material hardening processes to further increase yield strength, if desired

A size and shape of base plate 46 may be dependent on a desired application of machine 10. For example, a width W of base plate 46 (i.e., a dimension substantially orthogonal to the travel direction represented by arrow 50) may range through about 500-1000 mm (e.g., about 700-800 mm), while a thickness T of base plate may range through about 10-40 mm (e.g., about 20-30 mm). The width of base plate 46 may be selected to provide a desired ground pressure and/or traction characteristic of machine 10. The thickness of base plate 46 may be selected to assist in reducing the mass of the track shoe 30, while simultaneously maintaining sufficient yield strength for excavation and/or other track shoe applications and adequate wear and component life.

As shown in FIGS. 2 and 3, track shoe 30 may further include a vibration damping coating 58 applied at opposing transverse sides. Coating 58 may be made from a viscoelastic material, for example polyurethane. The polyurethane may be formed by a reaction between ether polyols or ether glycols and an isocyanate, such as diphenylmethane diisocyanate (MDI). In various other embodiments, coating 58 may be a polyurea or polyurethane/polyurea hybrid composite. Coating 58 may have a hardness of about 40 Shore A to about 80 Shore D, about 25 MPa minimum tensile strength, and a rebound value of up to about 55%.

In various embodiments, coating 58 may be formulated with one or more fillers to improve vibration attenuation. The fillers may include a high-density filler, such as barium sulfate, zinc oxide, gypsum, zinc sulfide, antimony trioxide, metallic particles, or the like. In one exemplary embodiment, coating 58 may be formulated with a mixture of the high-density fillers and low-density void-forming fillers in the polyurethane. The low-density void-forming fillers may include glass microspheres, polymeric microspheres, or ground foam particles. Alternatively, voids may be selectively formed in the polyurethane by chemical blowing agents, CO2 injection, or introducing water into the polyurethane mixture, which is known to generate CO2 as a byproduct when reacting with the isocyanates present in the polyurethane. A thixotropic material or gel-based agent may optionally be added in the polyurethane to avoid any stratification of the high-density filler particulate and the low-density void-forming material in the polyurethane. Alternatively, coating 58 may be fabricated from synthetic/natural polymer composites having properties similar to the above mentioned properties.

Coating 58 may be applied to only the opposing ends of each track shoe 30, so as to avoid the mating interface between inner surface 38 and side members 36 of links 20. In the disclosed embodiment, coating 58 may cover spaced-apart, generally-rectangular areas of base plate 46 that together consume about 40-50% of a width of base plate 46 (e.g., up to about 155 mm at each opposing end or about 310 mm together). The rectangular areas provided with coating 58 may extend further in the travel direction of base plate 46 than in the width direction, the rectangular areas extending from trailing end 48 rearward up to a point where the generally planar inner surface 38 of base plate 46 transitions to the curvature of leading end 52.

In the disclosed embodiment, coating 58 has a thickness t that is about as thick as base plate 46 (e.g., about 25 mm +/−15%) and includes complimentary curvatures at trailing and leading ends 48, 52. That is, the opposing ends of coating 58, in the travel direction, may have a curvature that matches the curvature at trailing and leading ends 48, 52. The curvature of coating 58 at trailing end 48 may be generally concentric and overlapping with the curvature of base plate 46, while the curvature of coating 58 at leading end 52 may be generally aligned (i.e., tangent) with the curvature of base plate 46 but terminate short of leading end 52. A thickness rebound ratio of coating 58 (i.e., a ratio of a thickness of coating 58 relative to the rebound value) may be about 0.45 mm/%. This ratio may provide a desired degree of dampening, while still preserving a required clearance between adjacent track shoes 30.

### INDUSTRIAL APPLICABILITY

The track shoe of the present disclosure may be applicable to any track-type mobile machine. The disclosed track shoe may have vibration damping qualities, thereby reducing an overall noise of machine 10. Further, the track shoes of the present disclosure may have high durability and low cost and weight. An exemplary fabrication of the disclosed track shoes will now be described in detail.

After base plate 46 and grouser bar 54 have been forged or cast, through processes known in the art, the component may be grit-blasted and cleaned. The grit-blasting and cleaning steps may be completed to remove flash, sand, grease, and/or oils that build up during the previous processes. Once inner surface 38 is clean and dry, an adhesive may be applied to the rectangular areas at opposing sides of base plate 46. In some embodiments, a primer or solvent may first be applied to inhibit oxidation before the adhesive is applied. The adhesive may be applied by dipping, spraying, brushing, and/or rolling, as desired.

Once the adhesive has been applied to inner surface 38 and, in the disclosed embodiment, before the adhesive has dried, coating 58 of polyurethane (or a hybrid mixture including polyurethane) may be applied over the layer of adhesive. As described above, coating 58 may be applied in a layer about as thick as base plate 46 and in a rectangular shape that covers about 40-50% of the width of base plate 46. It is contemplated that the polyurethane may be applied in any manner known in the art, for example in a liquid state via centrifugal molding, vacuum casting, injection molding, spraying, etc. Both the adhesive and the polyurethane may then be simultaneously cured, for example in an oven at temperatures up to about 300° F., to bond the polyurethane to inner surface 38 of base plate 46.

It will be apparent to those skilled in the art that various modifications and variations can be made to the disclosed track shoe. Other embodiments will be apparent to those skilled in the art from consideration of the specification and practice of the disclosed track shoe. It is intended that the specification and examples be considered as exemplary only, with a true scope being indicated by the following claims and their equivalents.

What is claimed is:

1. A track shoe for a mobile machine, comprising:
a base plate having an inner surface and an outer surface;
a grouser bar extending from the outer surface away from the base plate; and
a vibration damping coating applied to opposing ends of the base plate at the inner surface, the vibration damping coating having a thickness about equal to a thickness of the base plate.

2. The track shoe of claim 1, wherein the vibration damping coating is made from polyurethane.

3. The track shoe of claim 1, wherein the vibration damping coating includes a damping filler fabricated from at least one of barium sulfate, zinc oxide, and/or polymeric microspheres.

4. The track shoe of claim 1, wherein the vibration damping coating has a rebound value of up to about 55%.

5. The track shoe of claim 1, wherein the vibration damping coating has a tensile strength of about 25 MPa or greater.

6. The track shoe of claim 1, wherein the vibration damping coating has a hardness of about 40 Shore A to about 80 Shore D.

7. The track shoe of claim 1, wherein the inner surface is configured to directly engage a chain link.

8. The track shoe of claim 1, wherein:
the base plate has notches configured to accommodate a chain link; and
the vibration damping coating is applied outward of the notches.

9. The track shoe of claim 8, wherein the vibration damping coating covers about 40-50% of a width of the base plate.

10. The track shoe of claim 1, wherein:
the base plate has a curved leading end; and
the vibration damping coating includes a complimentary curved first end generally aligned with the curved leading end of the base plate.

11. The track shoe of claim 10, wherein:
the base plate also has a curved trailing end; and
the vibration damping coating includes a complimentary curved second end generally aligned with the curved trailing end of the base plate.

12. The track shoe of claim 1, wherein the vibration damping coating is molded or cast in place on the base plate.

13. The track shoe of claim 12, wherein the vibration damping coating is bonded to the base plate through a curing process.

14. The track shoe of claim 1, wherein a thickness rebound ratio of the vibration damping coating is about 0.45 mm/%.

15. A track shoe for a mobile machine, comprising:
a base plate having an inner surface and an outer surface;
a grouser bar extending from the outer surface away from the base plate; and
a polyurethane coating bonded to the inner surface at opposing ends of the base plate and covering about 40-50% of a width of the base plate.

16. The track shoe of claim 15, wherein the polyurethane coating has a rebound value of up to about 55%.

17. The track shoe of claim 15, wherein the polyurethane coating has a tensile strength of about 25 MPa or greater.

18. The track shoe of claim 15, wherein the polyurethane coating has a hardness of about 40 Shore A to about 80 Shore D.

19. The track shoe of claim 15, wherein:
the base plate has a curved leading end and a curved trailing end; and
the polyurethane coating includes:
a complimentary curved first end generally aligned with the curved leading end of the base plate; and
a complimentary curved second end generally aligned with the curved trailing end of the base plate.

20. An undercarriage for a mobile machine, comprising:
a drive sprocket;
an idler wheel spaced apart from the drive sprocket;
a plurality of chain links pinned end-to-end to form an endless loop wrapped around the drive sprocket and the idler wheel; and
a track shoe connected to each of the plurality of chain links, the track shoe having:
a base plate with an inner surface directly engaged with a corresponding one of the plurality of chain links, and an outer surface;
a grouser bar extending from the outer surface away from the base plate; and
a polyurethane coating bonded to opposing ends of the base plate at the inner surface, the polyurethane coating having:
a thickness about equal to a thickness of the base plate;
a rebound value up to about 55%;
a tensile strength of about 25 MPa or greater; and
a hardness of about 40 Shore A to about 80 Shore D.
